(19) United States
(12) Patent Application Publication
(10) Pub. No.: US 2022/0171431 A1
(43) Pub. Date: Jun. 2, 2022

(54) Foldable Display

(71) Applicant: Peratech Holdco Ltd, Brompton on Swale, Richmond (GB)

(72) Inventors: Apostolos Theocharis Voutsas, Vancouver, WA (US); Matthew Gospel, Scorton (GB)

(21) Appl. No.: 17/434,153

(22) PCT Filed: Mar. 2, 2020
(86) PCT No.: PCT/GB2020/000025

§ 371 Date: Aug. 26, 2021

Related U.S. Application Data
(60) Provisional application No. 62/812,303, filed on Mar. 1, 2019.

(51) Int. Cl. G06F 1/16; G06F 3/041

(52) U.S. Cl. CPC G06F 1/1641; G06F 3/0414; G06F 1/1647; G06F 1/1652

(57) ABSTRACT

A foldable electronic device (101) includes a display device (102) moveable from an unfolded configuration to a folded configuration in which the display device folds along a fold axis (103). The electronic foldable device further includes a force sensing device (603) responsive to a manual interaction on the surface of the display device. The force sensing device is positioned on the fold axis of the display device.

### CROSS REFERENCE TO RELATED APPLICATIONS

This application claims priority from U.S. Provisional Patent Application No. 62/812,303, filed on 1 Mar. 2019, the whole contents of which are incorporated herein by reference.

### BACKGROUND OF THE INVENTION

The present invention relates to a foldable electronic device, method of manufacturing a foldable electronic device and method of determining a mechanical interaction in a foldable electronic device.

Recent developments in electrical technology have resulted in foldable or flexible electronic devices becoming available. Increasingly, foldable or flexible displays have become available which allow the display to bend during use. Beyond this, there is a need for developments to enable increased functionality addressing problems which exist with foldable displays which are not present in conventional non-folding displays or electronic devices.

### BRIEF SUMMARY OF THE INVENTION

According to an aspect of the present invention, there is provided a foldable electronic device, comprising: a display device moveable from an unfolded configuration to a folded configuration in which said display device folds along a fold axis; a force sensing device responsive to a manual interaction on a surface of said display device; wherein said force sensing device is positioned on said fold axis of said display device.

According to a further aspect of the present invention, there is provided a method of manufacturing a foldable electronic device, comprising the steps of: providing a force sensing device responsive to a manual interaction; attaching said force sensing device to a display device configured to move from an unfolded configuration to a folded configuration along a fold axis; wherein: said step of attaching comprises positioning said force sensing device on said fold axis of said display device.

According to a still further aspect of the present invention, there is provided a method of determining a mechanical interaction in a foldable electronic device, said foldable electronic device comprising a display device and a force sensing device on a surface of said display device, said method comprising the steps of: folding said display device along a fold axis such that said display device moves from an unfolded configuration to a folded configuration; applying a manual interaction to said force sensing device positioned on said fold axis.

Embodiments of the invention will be described, by way of example only, with reference to the accompanying drawings. The detailed embodiments show the best mode known to the inventor and provide support for the invention as claimed. However, they are only exemplary and should not be used to interpret or limit the scope of the claims. Their purpose is to provide a teaching to those skilled in the art. Components and processes distinguished by ordinal phrases such as “first” and “second” do not necessarily define an order or ranking of any sort.

### BRIEF DESCRIPTION OF THE SEVERAL VIEWS OF THE DRAWINGS

FIG. 1 shows an example foldable electronic device in accordance with the invention;

FIG. 2 shows a cross-sectional exploded view of a corner of the edge of a foldable electronic device;

FIGS. 3A and 3B show the foldable electronic device in an unfolded configuration and use of force sensing devices positioned along the edge of the surface of the display from the front and back of the foldable electronic device;

FIG. 4 shows an example force sensing device;

FIG. 5 shows an alternative example force sensing device;

FIG. 6 shows a foldable electronic device having an in-folding and out-folding display surface;

FIG. 7 shows an embodiment of the foldable electronic device in a folded configuration in which a force sensing device is positioned on the fold axis of the display device; and

FIG. 8 shows an alternative view of the configuration of the foldable electronic device as shown in FIG. 7.

### DETAILED DESCRIPTION OF EMBODIMENTS OF THE INVENTION

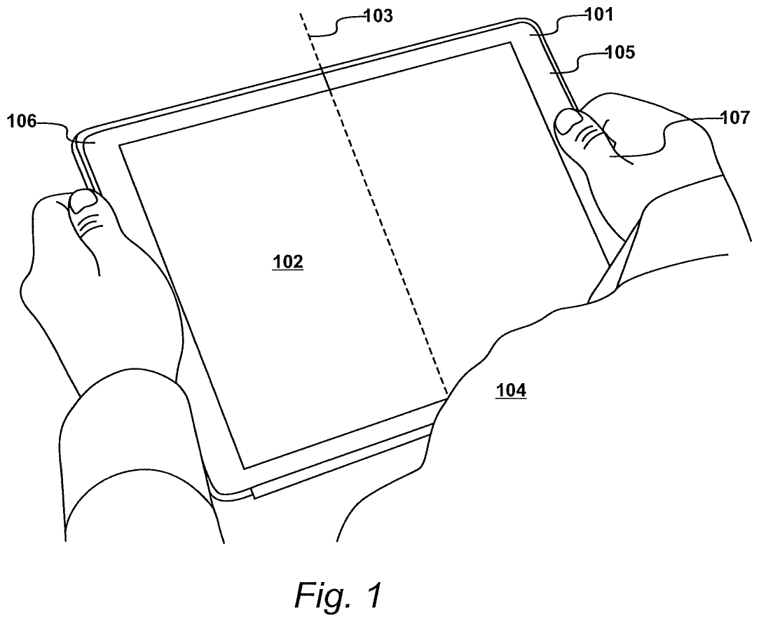

### FIG. 1

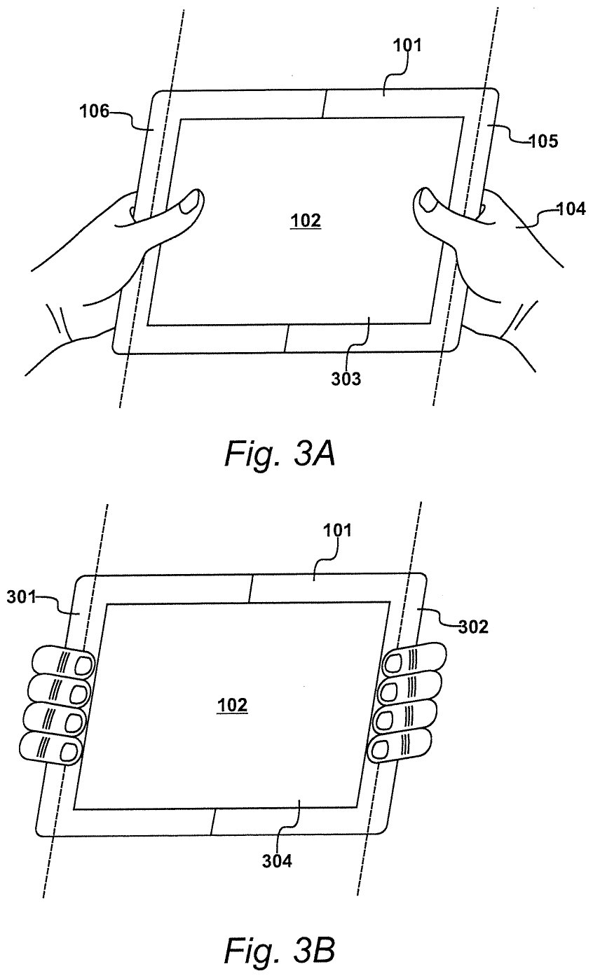

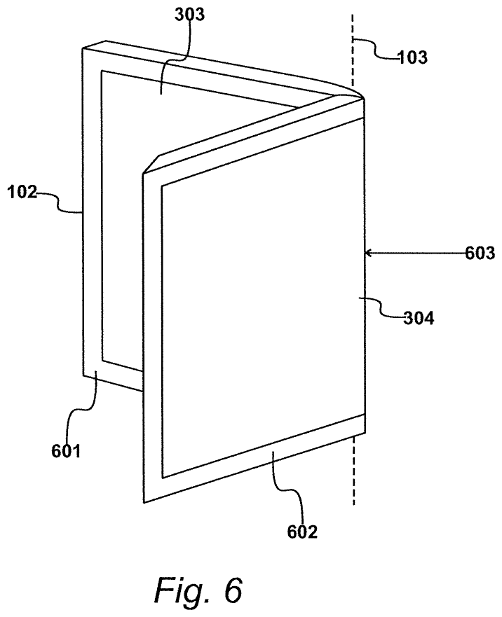

An example foldable electronic device is shown in use in FIG. 1. Foldable electronic device 101 comprises a display device 102 which is configured to be moveable from an unfolded configuration (as depicted in the examples of FIGS. 1 and 3) to a folded configuration (as depicted in the examples of FIGS. 6 to 8) about a fold axis 103.

In the embodiment, user 104 holds foldable electronic device 101 in the unfolded configuration so as to view the display of display device 102. In the embodiment, display device 102 comprises a touch screen in which user 104 may provide a mechanical interaction to display device 102 to receive an output on the display of foldable electronic device.

In the embodiment, foldable electronic device 101 is shown as a tablet computer, however, it is appreciated that alternative foldable electronic devices fall within the scope of invention, and include other display devices, mobile telephones, personal computers, televisions, media players or similar.

In the embodiment, foldable electronic device 101 comprises at least one force sensing device which is responsive to a mechanical interaction, such as an applied pressure or force from user 104 which is positioned on a surface of the display device. In the embodiment, foldable electronic device 101 comprises one or more force sensing devices positioned along the edges 105, 106 of display device 102. Thus, in use, user 104 can apply a pressure by means of finger or thumb 107 to edge 105 for example to provide a signal to foldable electronic device 101 to activate a predetermined output.

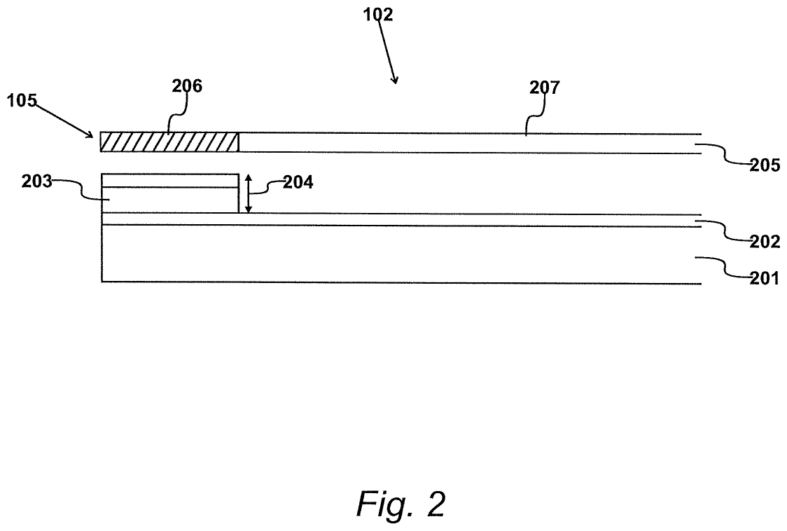

### FIG. 2

A cross sectional exploded view of the corner of edge 105 of foldable electronic device 101 is shown in FIG. 2. Display device 102 comprises a light-emitting layer 201 which provides a light output to a display device 102. Display device 102 also comprises a touch sensitive layer 202 which is configured to measure a force in response to a mechanical interaction and provide a touch screen capacity in any suitable conventional manner.

At the edge 105 of foldable electronic device 101, force sensing device 203 is positioned so as to enable a response to be provided to a mechanical interaction applied along edge 105. Force sensing device 203 may comprise any suitable force sensing device capable of measuring a force in response to a mechanical interaction. In an embodiment, force sensing device 203 is configured to provide positional (x, y) and extent (z) properties in response to a mechanical interaction, such as an applied force or pressure.

In an embodiment, the total height 204 of force sensing device 203 is between one hundred and one hundred and fifty micrometres (100-150 μm). In a particular embodiment, the height 204 is one hundred micrometres (100 μm). Force sensing device 203 is configured to conform to these dimensions to enable display device 102 to be made as thin as possible.

Display device 102 further comprises a top cover 205, shown in exploded view, and, in this illustrated embodiment, an edge portion 206 of top cover 205 is configured to cover force sensing device 203. Portion 207 of top cover 205 comprises a transparent area which allows light output from light-emitting layer 201 to be transmitted through the display.

It is appreciated that any number of force sensing devices may be positioned around any part of the edges of display device 102 to provide an input device to user 104. As will now be described, FIG. 3 illustrates an example embodiment of positioning of force sensing devices on the edge of foldable electronic device 101.

### FIGS. 3A and 3B

In the embodiment of FIG. 3A foldable electronic device 101 comprises a plurality of force sensing devices positioned along front edges 105 and 106 of the surface of foldable electronic device 101. FIG. 3A therefore illustrates foldable electronic device from a front side of display device 102.

In contrast, FIG. 3B, foldable electronic device 101 is shown from a rear side of display device 102 and comprises a plurality of force sensing devices along rear edges 301 and 302.

In the embodiment, foldable electronic device 101 comprises a first display 303 on the front side as per FIG. 3A and a second display 304 on a rear side as per FIG. 3B. In the embodiment, front side and rear side are substantially opposite to each other as illustrated.

In the embodiment, user 104 grips foldable electronic device 101 in a conventional manner, such that the thumbs of both the right and left hands are proximate to the front side of FIG. 3A and the fingers of the right and left hands are proximate to the rear side of FIG. 3B. In this way, when the display device is in the unfolded configuration of FIG. 3, user 104 is able to ergonomically operate any force sensing devices arranged along front edges 105, 106 with their thumbs, and rear edges 301, 302 with their fingers.

The force sensing devices along any of the edges may be configured to provide navigation, scrolling, selection of applications (apps), launch of applications (apps), control volume, control zoom, or any number of any other required functions specific to applications in use. The use of force sensing devices in this way may augment other sensing devices present in the foldable electronic device, for example, capacitive touch sensors forming the touch screen or other sensing devices.

The configuration described in FIG. 3 provides many advantages for folding displays which are of a size which require a two-handed grip. In this case, the user does not usually have a free hand to interact with the display or touch screen in a conventional manner. In addition, the placement of force sensing devices on the rear side enables improved user interface for certain applications, such as in gaming. Any of the force sensing devices may also be utilised for operation of the foldable electronic device from either the front side of FIG. 3A or the rear side of FIG. 3B.

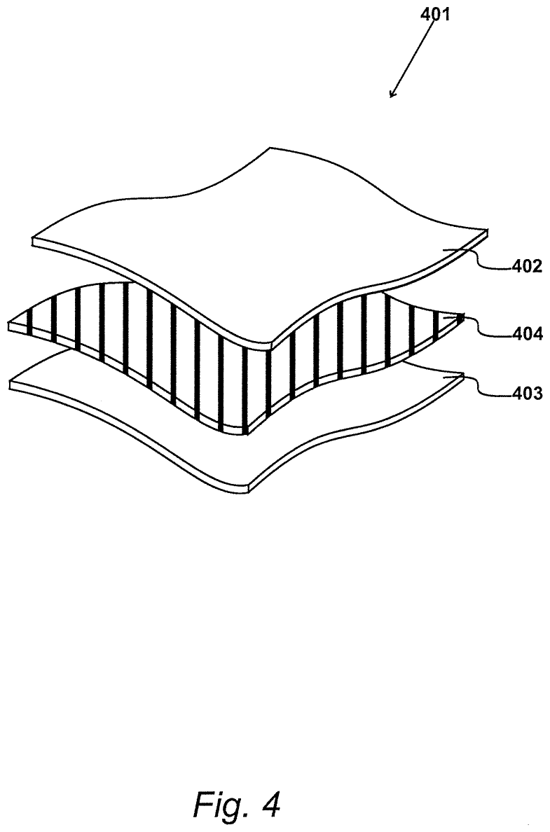

### FIG. 4

An example force sensing device which may be utilised along the edges of foldable electronic device 101 is shown in FIG. 4. It is appreciated that the force sensing device 401 of FIG. 4 may also be utilised in any other capacity in the foldable electronic device, such as the force sensing devices shown in the embodiments of FIGS. 6 to 8.

A schematic exploded view of force sensing device 401 is shown in FIG. 4. Force sensing device 401 comprises a first conductive layer 402 and a second conductive layer 403. A pressure sensitive layer 404 is positioned between conductive layer 402 and conductive layer 403.

In the embodiment, the first conductive layer 402, second conductive layer 403 and pressure sensitive layer 404 are sequentially printed as inks onto a substrate 204 to form a force sensing device. Thus, each of the layers are printed in close proximity rather than the exploded view of FIG. 4. Conductive layers 402 and 403 may comprise a carbon-based material and/or a silver-based material. Pressure sensitive layer 404 comprises a pressure sensitive material such as the type supplied by the applicant Peratech Holdco Limited, Brompton-on-Swale, United Kingdom, under the trade mark QTC®. The pressure sensitive material therefore may comprise a quantum tunnelling composite material which is configured to exhibit a change in electrical resistance based on a change in applied force. The quantum tunnelling composite material may be supplied as a printable ink or film.

In use, when a pressure is applied to the layers, a conductive path is created which enables calculation of an extent property or intensity of a force applied, in a substantially conventional manner by interpretation of the electrical outputs. In this way, the layers of force sensing device 401 can be arranged to form a single point sensor, which can subsequently be applied to foldable electronic device 101 where force sensing devices are required.

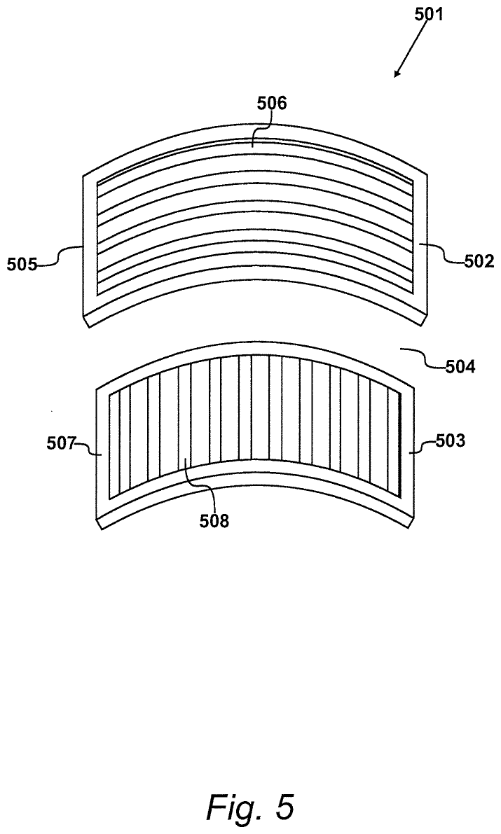

### FIG. 5

An alternative example force sensing device which may be utilised in foldable electronic device 101 in any manner discussed herein is shown in FIG. 5.

Force sensing device 501 is shown in a partially exploded view and comprises a first conductive layer 502 and a second conductive layer 503. In this diagrammatic illustration, first conductive layer 502 and second conductive layer 503 are shown in an exploded form such that there is a gap 504 between them. It is appreciated that, in practice, first conductive layer 502 and second conductive layer 503 are positioned closer together than shown and in some embodiments, gap 504 is negligible.

In combination, conductive layer 502 and conductive layer 503 combine to define a sensing region which can determine a mechanical interaction such as a force or pressure applied by means of a user's finger, thumb or stylus press. In the embodiment, conductive layer 502 and conductive layer 503 are configured to be substantially flexible such that they are able to bend or flex in use. In addition, the layers may be suitably constrained to allow movement to provide a flexible sensor which does not suffer from false triggering. An example of such a sensor is described in GB 2 557 894 in the name of the present applicant.

Conductive layer 502 comprises a substrate 505 which comprises a plurality of conductive rows 506 printed onto substrate 505. In a similar way, conductive layer 503 comprises substrate 507 onto which a plurality of conductive columns 508 are printed. Each row is electrically insulated from the others, and similarly, each column is electrically insulated from the others.

The conductive rows and columns of each of the conductive layers are configured to cooperate in the manner of a matrix sensor such that positional (x, y) and extent (z) properties of a mechanical interaction can be determined. Thus, in response to a mechanical interaction, the rows and columns are brought together which allows an electrical potential gradient to be established and position to be determined.

In the embodiment, conductive rows 506 comprise a layer of silver-loaded ink and a layer of carbon loaded ink. Similarly, conductive columns 508 comprise a layer of silver-loaded ink which is then overprinted with a conductive carbon loaded ink. Conductive layer 503 further comprises a pressure sensitive material such as a quantum tunnelling material. Again, this may be a material of the type supplied by the present applicant Peratech Holdco Limited under the trade mark QTC®. In the embodiment, the quantum tunnelling material is overprinted over the conductive carbon ink with the silver, carbon and quantum tunnelling material in combination forming the plurality of conductive columns 508.

It is appreciated that, in alternative embodiments, the quantum tunnelling material is printed on substrate 505 and forms part of conductive layer 502 rather than conductive layer 503. It is further appreciated that in a further embodiment both conductive layer 502 and conductive layer 503 both comprise layers of quantum tunnelling material.

With respect to the use of the terminology “rows” and “columns”, it is appreciated that rows 506 and columns 508 are positioned parallel to one another within the first conductive layer 502 and second conductive layer 503 respectively. The plurality of rows are also positioned substantially perpendicularly to the plurality of columns, albeit in separate planes relating to the first conductive layer 502 and the second conductive layer 503 respectively.

### FIG. 6

Foldable electronic device 101 comprising display device 102 has been moved from the unfolded configuration (as depicted in the examples of FIGS. 1 and 3 described previously) to the folded configuration shown in FIG. 6.

In the embodiment, display device 102 have been folded along fold axis 103. In this way, foldable electronic device 101 operates in a manner similar to that of the unfolded configuration, allowing user 104 to provide input by means of mechanical interactions such as a force or pressure input arising from a finger press or similar.

In the embodiment, foldable electronic device 101 comprises first display 303 and second display 304. As described previously, first display 303 is positioned on a front side 601 of display device 102 and second display device 304 is positioned on a rear side 602 of display device 102 which is substantially opposite to the front side 601.

In the embodiment, foldable electronic device 101 comprises at least one force sensing device which is responsive to a manual interaction on the surface of display device 102. As explained previously, foldable electronic device comprises force sensing devices positioned along the front and rear edges of display device 102. In this way, when the foldable electronic device is in the folded configuration, the force sensing device(s) along the front and rear edges the edge may be configured to serve secondary display(s) that appear on the folded surface. Thus, use of the foldable electronic device can be made in either folded or unfolded form.

In this embodiment, in addition to the force sensing devices positioned along the front and rear edges of display device 102, foldable electronic device further comprises at least one force sensing device 603 on fold axis 103, as will be explained further with respect to FIG. 6.

In the embodiment, when display device 102 is in the unfolded configuration of FIG. 1, a signal may be provided from force sensing device 603 by application of a pressure or other mechanical interaction directly to the surface of display device and force sensing device 603. However, in the folded configuration, an alternative signal may be provided from force sensing device 603 which provides an alternative output to a processor of the foldable electronic device in response to the folding of display device and alteration of the configuration. Additionally, the first signal in the unfolded configuration may provide a control signal to display 303 and the second signal in the folded configuration may provide a control signal to display 304.

As shown, display 303 is inward-folding and in contrast, display 304 is outward-folding in the sense that display 304 extends across an outer surface of display device 102 and display 303 extends across an inner surface of display device 102, and fold axis 103 extends along the edge of the outer surface.

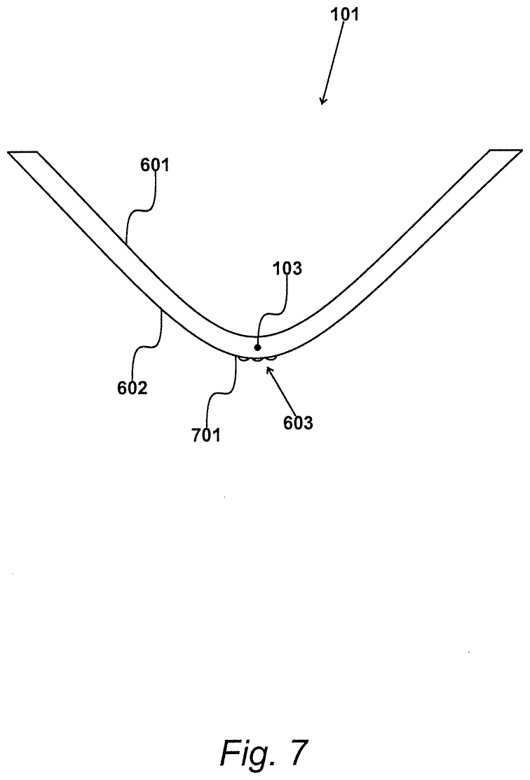

### FIG. 7

A side view of foldable electronic device 101 in the folded configuration of FIG. 6 is illustrated in FIG. 7. A plurality of force sensing devices 603, such as for example force sensing devices 401 or 501 are provided and attached along fold axis 103 which extends into the page as shown.

When foldable electronic device 101 is in the folded configuration, the folded surface 701 to which the force sensing devices 603 are attached thereto enables surface 701 to utilised as an additional input control surface. By providing suitably flexible force sensing devices, these can be utilised without false triggering.

In addition, with the force sensing devices positioned on the fold axis 103, when the foldable electronic device 101 is folded into the folded configuration, the sensitivity of the force sensing device on the folded surface can be taken advantage of.

In the embodiment, force sensing devices 603 are positioned on the rear side of the display device. It is appreciated however, that in alternative embodiments, force sensing devices 603 may be positioned on the front side of the display device to provide a varied function.

While the embodiment also indicates a plurality of force sensing devices, it is appreciated that, in alternative embodiments, a single force sensing device may be utilised, for example, such as a force sensing device as described herein but mounted along the entire length of fold axis 103 of foldable electronic device 101. Alternatively, a single force sensing device may also be utilised that only exists on part of the length of fold axis 103. It is anticipated that further alternative embodiments having varying arrangements and numbers of force sensing devices along fold axis 103 may also be provided.

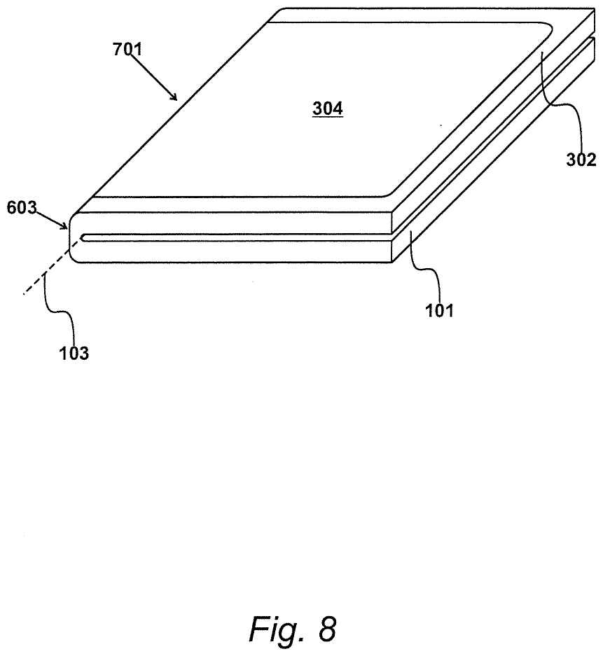

### FIG. 8

The folded configuration previously described with respect to FIGS. 6 and 7 is shown further in FIG. 8. It is appreciated that, in the unfolded configuration, the display device 102 extends in a single plane such that the foldable electronic device 101 extends substantially horizontally. As the two halves of the foldable electronic device are brought together by folding along fold axis 103, the folded configuration is entered and may extend from the zero-degree position of the unfolded configuration to a ninety-degree position in which each of the two halves are brought entirely together, as shown in FIG. 8.

In this embodiment, display 303, being inward-folding, is no longer visible to a user, however, display 304 is visible and is configured to present any required outputs from foldable electronic device 101. In this embodiment therefore, force sensing devices positioned along edge 302 can be utilised to operate output onto display 304. In addition, force sensing device 603 can be used along fold axis 103 to provide further output to display 304.

In particular, it is envisaged that this feature may be suitable to provide further capacity in gaming applications, in which a user may apply a force directly to the folded surface 701 to give an ergonomic response.

1-18. (canceled)

19. A foldable electronic device, comprising:
a display device moveable from an unfolded configuration to a folded configuration in which said display device folds along a fold axis;
a first display on a front side of said display device, and a second display on a rear side of said display device, said front side being substantially opposite to said rear side;
a force sensing device positioned on said fold axis of said display device, said force sensing device being responsive to a mechanical interaction, including a finger press from a user, and configured to provide positional (x, y) and extent (z) properties of said mechanical interaction;
said force sensing device is further configured to provide a first control signal configured to control said first display or a second control signal configured to control said second display;
said first control signal is provided from said force sensing device in response to said mechanical interaction when said display device is in said unfolded configuration; and
said second control signal is provided from said force sensing device in response to said mechanical interaction when said display device is in said folded configuration.

20. A foldable electronic device according to claim 19, wherein said first display is inward-folding relative to said second display and said second display is outward-folding relative to said first display.

21. A foldable electronic device according to claim 19, wherein said force sensing device is positioned on said front side.

22. A foldable electronic device according to claim 19, wherein said force sensing device is positioned on said rear side.

23. A foldable electronic device according to claim 19, further comprising a further force sensing device, wherein said further force sensing device is positioned on at least one edge of said surface.

24. A foldable electronic device according to claim 19, further comprising a plurality of force sensing devices.

25. A foldable electronic device according to claim 19, wherein said foldable electronic device is a mobile telephone.

26. A foldable electronic device according to claim 19, wherein said force sensing device comprises a quantum tunneling material.

27. A foldable electronic device according to claim 19, wherein said force sensing device comprises a matrix sensor comprising a plurality of rows and a plurality of columns.

28. A foldable electronic device according to claim 19, wherein said force sensing device comprises a single point sensor.

29. A method of manufacturing a foldable electronic device, comprising the steps of:
providing a force sensing device responsive to a mechanical interaction, including a finger press from a user, said force sensing device being further configured to provide positional (x, y) and extent (z) properties of said mechanical interaction;
providing a display device configured to move from an unfolded configuration to a folded configuration along a fold axis, said display device having a first display on a front side of said display device, and a second display on a rear side of said display device, said front side being substantially opposite to said rear side;
attaching said force sensing device to said display device; wherein:
said step of attaching comprises positioning said force sensing device on said fold axis of said display device;
configuring said force sensing device to provide a first control signal configured to control said first display or a second control signal configured to control said second display;
configuring said first control signal to be provided from said force sensing device in response to said mechanical interaction when said display device is in said unfolded configuration; and
configuring said second control signal to be provided from said force sensing device in response to said mechanical interaction when said display device is in said folded configuration.

30. A method of manufacturing according to claim 29, wherein said step of attaching comprises attaching said force sensing device to an outer surface of said display device.

31. A method of determining a mechanical interaction in a foldable electronic device, said foldable electronic device comprising a display device and a force sensing device on a surface of said display device, said display device comprising a first display on a front side of said display device, and a second display on a rear side of said display device, said front side being substantially opposite to said rear side;
said method comprising the steps of:
folding said display device along a fold axis such that said display device moves from an unfolded configuration to a folded configuration;
applying a mechanical interaction, including a finger press from a user, to said force sensing device positioned on said fold axis;
calculating positional (x, y) and extent (z) properties of said mechanical interaction by said force sensing device;
providing a first control signal from said force sensing device in response to said mechanical interaction when said display device is in said unfolded configuration to control said first display; and
providing a second control signal from said force sensing device in response to said mechanical interaction when said display device is in said folded configuration to control said second display.
